(19) United States
(12) Patent Application Publication
(10) Pub. No.: US 2006/0232074 A1
(43) Pub. Date: Oct. 19, 2006

(54) Apparatus for generating electric power using wave force

(76) Inventor: Mario Chiasson, Quebec (CA)

Correspondence Address: Mr. Mario Chiasson, 824 St-Honore, Quebec, QC, G1J 2W3, CA

(21) Appl. No.: 11/108,049

(22) Filed: Apr. 18, 2005

(51) Int. Cl. F03B 13/12; F03B 13/10; H02P 9/04

(52) U.S. Cl. 290/53

(57) ABSTRACT

The present invention concerns an apparatus for generating electric power using wave force. The apparatus is composed of a floater attached to a lever which moves up and down with the motion of wave, which transfers the oscillatory movement to a driving shaft to rotate a gear wheel for generating a rotation force that is transferred to a flywheel connected to a shaft to drive a large pulley which carries a flat belt that is engaged with a small pulley for transmitting motion and power to activate an electric generator to run and yield electricity, and small gears to rotate on the shaft and to reverse the direction of the rotation force of the gear wheel causing the lever to oscillate.

### BACKGROUND OF THE INVENTION

1. Field of the Invention

The present invention relates to an apparatus to produce electrical energy with the wave force.

2. Description of the Related Art

Since realizing the application of electricity, various methods have been used to generate electricity.

A search of prior art records has unveiled the following patents:
1. CA 2,323,516 registered in 1999 to Waughen;
2. U.S. Pat. No. 6,392,314 issued in 2002 to Dick;
3. U.S. Pat. No. 5,854,516 issued in 1998 to Shim;
4. US 2003110767 registered in 2003 to Lee;
5. U.S. Pat. No. 4,210,821 issued in 1980 to Cockerell; and
6. U.S. Pat. No. 6,323,563 issued in 2001 to Kallenberg.

The patent to Lee is probably the most relevant. As can be seen, the patent to Lee shows a method and an installation of applying ocean wave to power generation, which utilizing the principle of levers to convert the power of ocean wave into mechanical power, and then convert the mechanical power into electricity.

The proposed system, has simple structure and can easily increase or decrease the enlargement mechanism according to the capacity of generation.

It is easy to install it into the rivers, oceans, seas or tidal bridge, because the system uses the wave force, and that, it is no necessary to build the water dams.

### SUMMARY OF THE INVENTION

The principle of the present is to generate electric power using wave force.

The concept of the present invention is that:

a floater drives a lever to move up and down with the motion of wave, which transfers the oscillatory movement to a driving shaft to rotate a gear wheel for generating a rotation force that is transferred to a flywheel connected to a shaft to drive a large pulley which carries a flat belt that is engaged with a small pulley for transmitting motion and power to activate an electric generator to run and yield electricity, and small gears to rotate on the shaft and to reverse the direction of the rotation force of the gear wheel causing the lever to oscillate.

### BRIEF DESCRIPTION OF THE SEVERAL VIEWS OF THE DRAWING(S)

FIGS. 1a, 1b are perspective side views of an apparatus installed in working position for generating electric power with the wave force.

FIGS. 2, 3 are side views showing the operating state of the apparatus;

FIG. 4 is a top elevational view thereof.

FIGS. 5, 6 are exploded views showing the components in position for assembly.

### DETAILED DESCRIPTION OF THE INVENTION

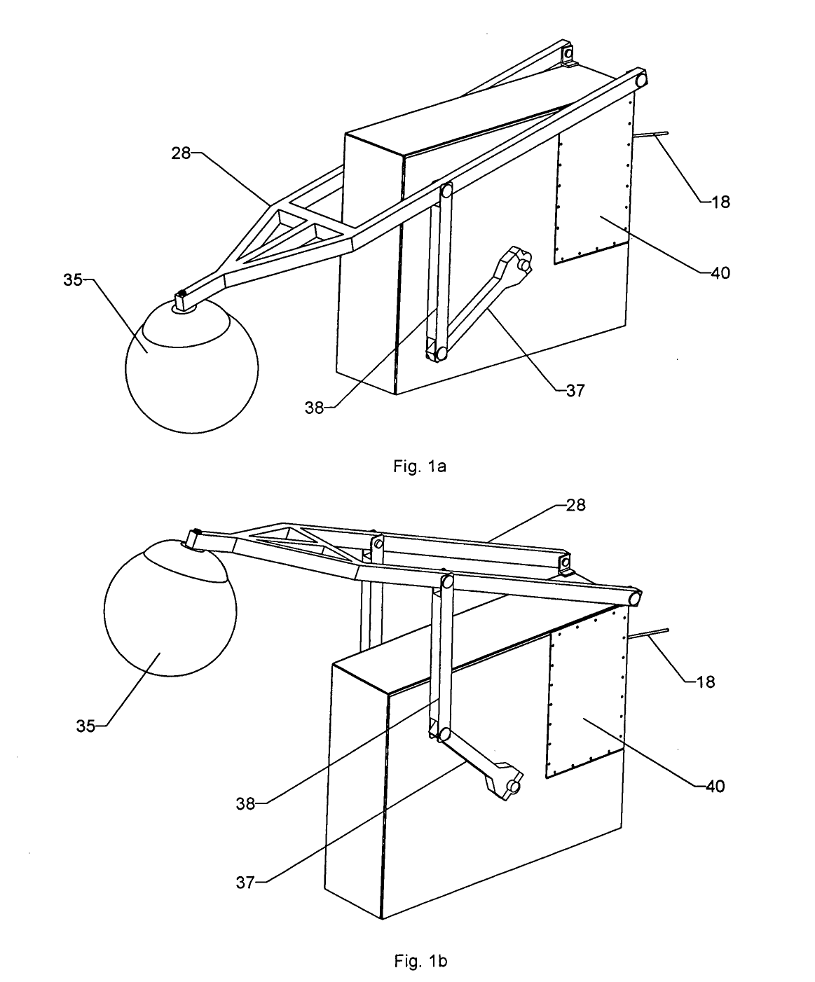

As illustrated in FIGS. 1a, 1b, it is shown an apparatus for generating electric power using wave force, which includes a case hermetically sealed and provided of a door (40) for easy maintenance, and a floater (35) being attached by a locking means (36) to one end of a lever (28) which is connected by pins (39) to case of the apparatus. Further, each side of the lever (28) is fixed by a pin (39) to the upper end an articulated arm (38)(37) being situated of each side of the case, and wherein its lower end fits with a driving shaft (3) through bushings (2) for the connection of the driving shaft (3), lever seals and bushings (29)(30)(31)(32)(33)(34).

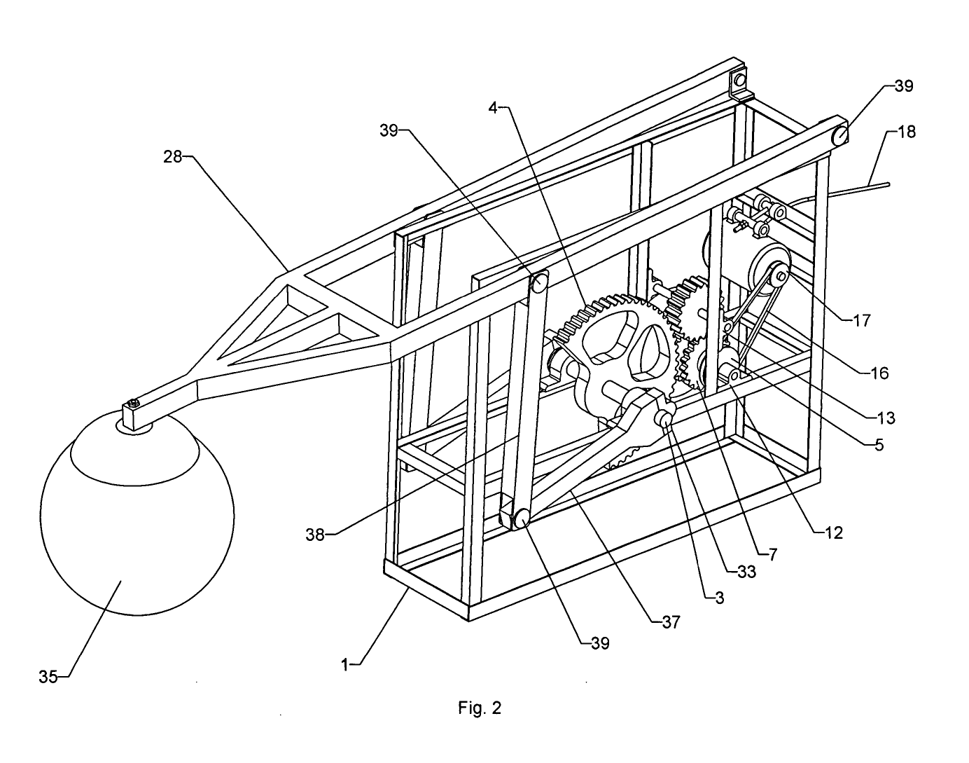

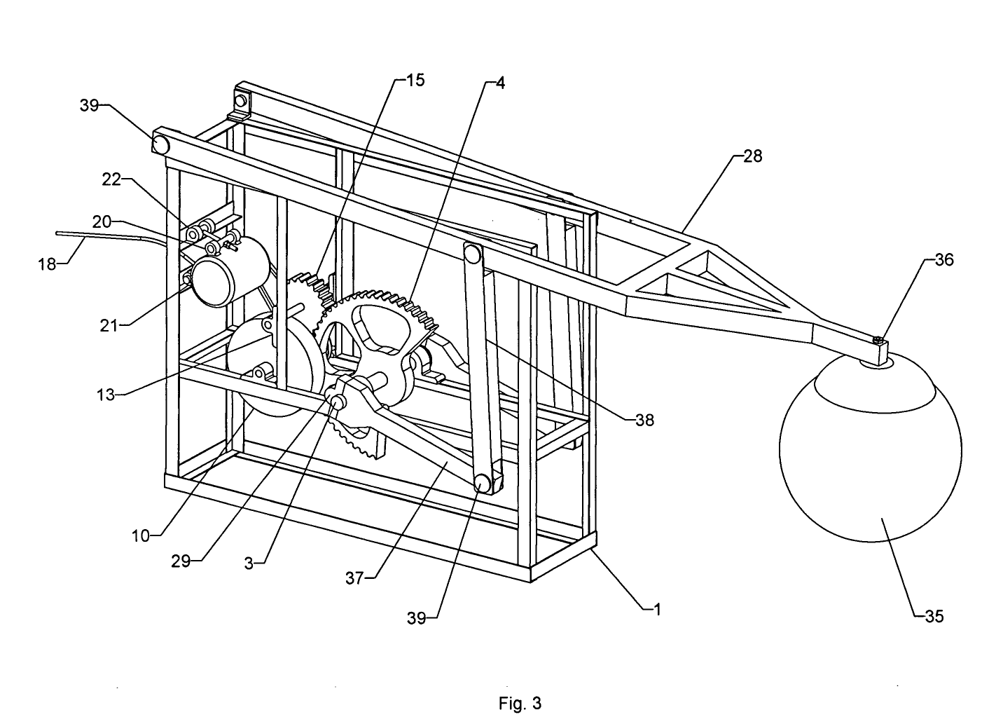

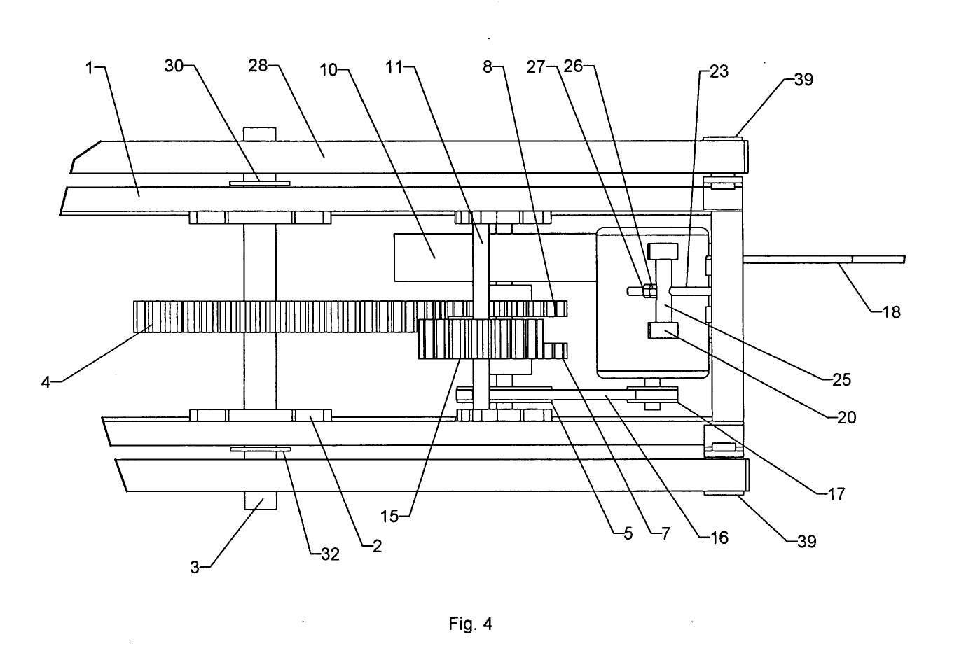

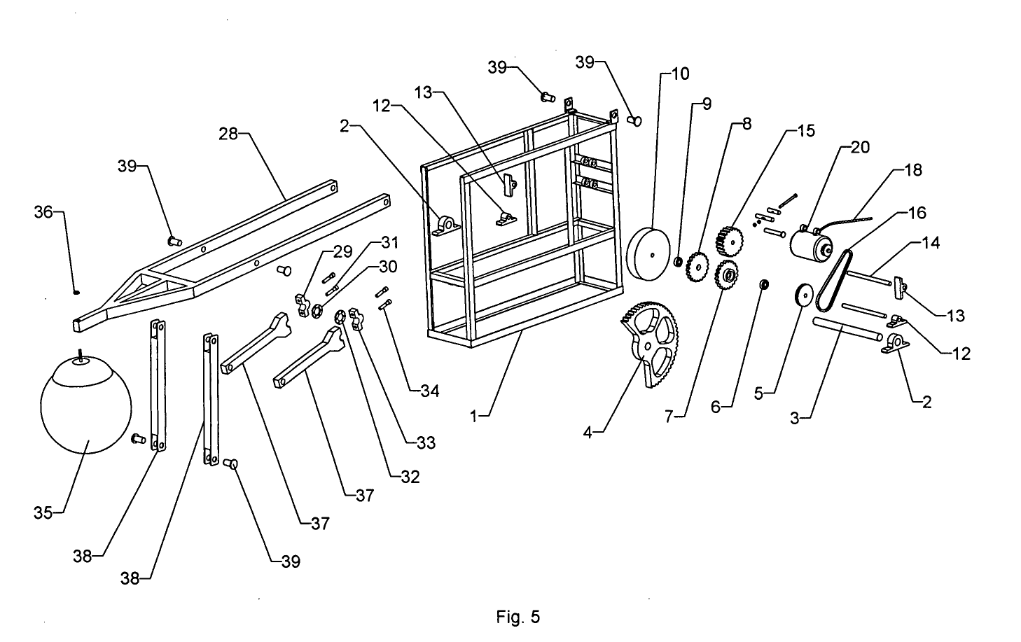

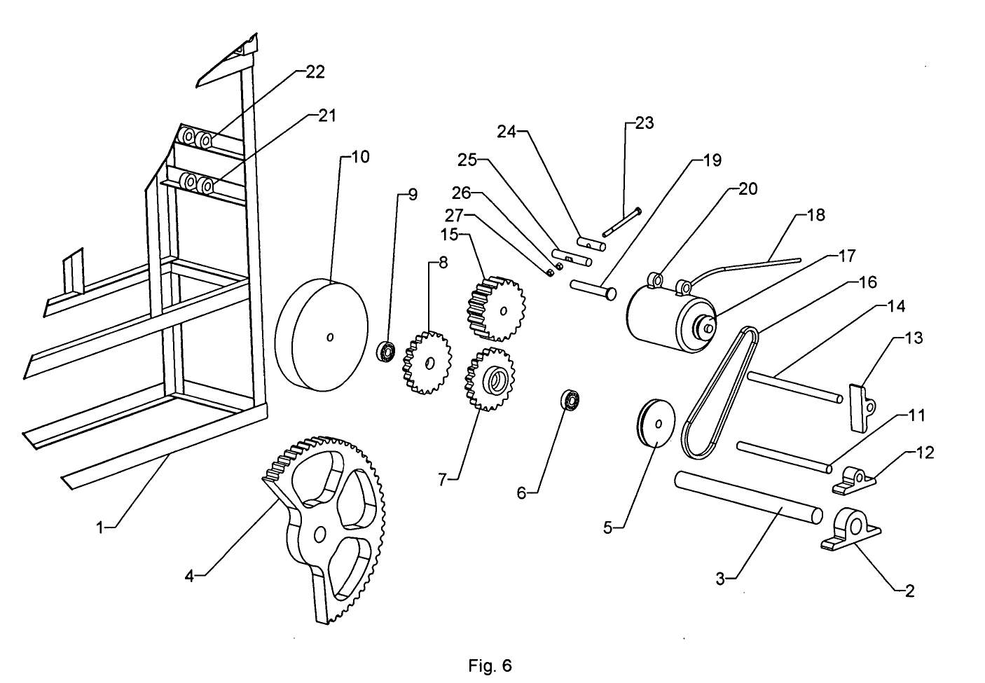

As illustrated in FIGS. 2, 3, 4, 5, 6, the floater (35) drives the lever (28) to move up and down with the motion of wave, which transfers the oscillatory movement to the driving shaft (3) to rotate a gear wheel (4) for generating a rotation force that is transferred to a flywheel (10) connected to a shaft (11) to drive a large pulley (5) which carries a flat belt (16) that is engaged with a small pulley (17) for transmitting motion and power to activate an electric generator (18) to run and yield electricity, small gears (7)(8) engaging a one-way bearing clutch (6)(9) to rotate on the shaft (11) through bushings (12) for the connection of the shaft (11), a gear (15) fitting with the small gear (7) to rotate on the shaft (14) through bushings (13) for the connection of the shaft (14) and to reverse the direction of the rotation force of the gear wheel (4) causing the lever (28) to oscillate. The electric generator (18) is mounted to the structure (1) by a pivot (19) which is engaged therethrough a pair of brackets mounted backward the electric generator (18) and brackets (21) mounted to the structure (1), a connecting rod (25) is engaged therethrough a pair of brackets (20), a connecting rod (24) is engaged therethrough a pair of brackets (22), and wherein a bolt (23) is engaged therethrough hole being formed therein each connecting rod (24)(25) and fixed thereby nuts (25)(26).

Although only a single embodiment of the present invention has been described and illustrated, the present invention is not limited to the features of this embodiment, but includes all variations and modifications within the scope of claims.

Legend:

1: Structure
2: Bushing
3: Driving shaft
4: Gear wheel
5: Large pulley
6: Bearing clutch
7: Gear
8: Gear
9: Bearing clutch
10: Flywheel
11: Shaft
12: Bushing
13: Bushing
14: Shaft
15: Gear
16: Belt
17: Small pulley
18: Generator with cable
19: Pivot
20: Bracket
21: Bracket
22: Bracket
23: Bolt
24: Connecting rod
25: Connecting rod
26: Nut
27: Nut
28: Lever
29: Bushing
30: Seal
31: Bolt
32: Seal
33: Bushing
34: Bolt
35: Floater
36: Locking means
37: Second part member of articulated arm
38: First part member of articulated arm
39: Pin
40: Door

The embodiments of the invention for which an exclusive property or privilege is claimed, are defined as follows:

1. An apparatus for generating electric power using wave force, which comprising a case enclosing a structure (1) being composed of a gear wheel (4), a flywheel (10), a large pulley (5), small gears (7)(8)(15), one-way bearing clutch (6)(9), a driving shaft (3), shafts (11)(14), bushings (2)(12) (13)(29)(33), a belt (16), a small pulley (17), brackets (20)(21)(22), a pivot (19), a bolt (23), connecting rods (24)(25), nuts (26)(27), and an electric generator (18);
a lever (28)
a floater (35); and
a door (40);
characterized in that the floater (35) is attached by a locking means (36) to one end of the lever (28) which is connected by pins (39) to the case of the apparatus, and wherein each side of said lever (28) is fixed by a pin (39) to the upper end of an articulated arm (38)(37) being situated of each side of said case, and wherein its lower end fits with a driving shaft (3) through bushings (2) for the connection of said driving shaft (3), lever seals and bushings (29)(30)(31)(32)(33)(34),
said floater (35) drives the lever (28) to move up and down with the motion of wave, which transfers the oscillatory movement to said driving shaft (3) to rotate said gear wheel (4) for generating a rotation force that is transferred to said flywheel (10) connected to said shaft (11) to drive said large pulley (5) which carries said flat belt (16) that is engaged with said mall pulley (17) for transmitting motion and power to activate said electric generator (18) to run and yield electricity, small gears (7)(8) engaging a one-way bearing clutch (6)(9) to rotate on said shaft (11) through bushings (12) for the connection of said shaft (11), a small gear (15) fitting with said small gear (7) to rotate on said shaft (14) through bushings (13) for the connection of said shaft (14) and to reverse the direction of the rotation force of said gear wheel (4) causing the lever (28) to oscillate, and means for connecting said electric generator (18) to said structure (1), characterized in that a pivot (19) is engaged therethrough a pair of brackets mounted backward said electric generator and brackets (21) mounted to said structure (1), a connecting rod (25) is engaged therethrough a pair of brackets (20), a connecting rod (24) is engaged therethrough a pair of brackets (22), and wherein a bolt (23) is engaged therethrough hole being formed therein each said connecting rod (25)(24) and fixed thereby nuts (26)(27).
